(19) United States
(12) Patent Application Publication
(10) Pub. No.: US 2009/0263694 A1
(43) Pub. Date: Oct. 22, 2009

(54) APPARATUS FOR GENERATING HYDROGEN AND FUEL CELL POWER GENERATION SYSTEM HAVING THE SAME

(75) Inventors: Kyoung-Soo CHAE, Suwon-si (KR); Jae-Hyuk JANG, Seoul (KR); Chang-Ryul JUNG, Seoul (KR); Sung-Han KIM, Suwon-si (KR); Hye-Yeon CHA, Yongin-si (KR); Jae-Hyoung GIL, Seoul (KR); Bo-Sung KU, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO.,LTD.

(21) Appl. No.: 12/419,087

(22) Filed: Apr. 6, 2009

(30) Foreign Application Priority Data
Apr. 17, 2008 (KR) 10-2008-0035506

(51) Int. Cl. H01M 8/06; C25B 9/00

(52) U.S. Cl. 429/21; 204/230.3

(57) ABSTRACT

Disclosed are an apparatus for generating hydrogen and a fuel cell power generation system that have the same. The apparatus in accordance with an embodiment of the present invention include: an electrolytic bath configured to contain electrolyte solution; an anode placed inside the electrolytic bath and configured to generate an electron; a cathode placed inside the electrolytic bath and configured to generate hydrogen by receiving the electron from the anode; a controller electrically connected to the anode and the cathode, and configured to control flow of electricity between the anode and the cathode; and a mechanical switch electrically connected to the controller in parallel and configured to flow electricity between the anode and the cathode in order to start the controller.

### CROSS-REFERENCE TO RELATED APPLICATIONS

This application claims the benefit of Korean Patent Application No. 10-2008-0035506, filed with the Korean Intellectual Property Office on Apr. 17, 2008, the disclosure of which is incorporated herein by reference in its entirety.

### BACKGROUND

1. Technical Field

The present invention relates to an apparatus for generating hydrogen and a fuel cell power generation system having the same.

2. Description of the Related Art

A fuel cell performs a function of directly converting chemical energy of fuel such as hydrogen, LNG, LPG, methanol etc., and air into electricity and heat through an electrochemical reaction. While a conventional power generation technology adopts fuel combustion, vapor generation, a turbine-driven process and a power generator-driven process, the fuel cell has neither the combustion process nor a drive device. Accordingly, the fuel cell is a new high efficiency, environmentally-friendly power generation technology.

Fuel cells being studied for application in small portable electronic devices include the Polymer Electrolyte Membrane Fuel Cell (PEMFC), which uses hydrogen as the fuel, and a direct liquid fuel cell, such as the Direct Methanol Fuel Cell (DMFC), which uses liquid fuel. The Polymer Electrolyte Membrane Fuel Cell has a high power density but requires a separate device for supplying hydrogen. If a hydrogen storage tank, etc., are used so as to supply hydrogen, the PEMFC has a large volume and may have a danger which may be caused by keeping the hydrogen therein.

Methods of generating hydrogen as fuel for the Polymer Electrolyte Membrane Fuel Cell use aluminum oxidation reaction, hydrolysis of metallic borohydrides or metallic electrode reaction, among which the metallic electrode reaction method can efficiently control the hydrogen generation. Generating hydrogen through a water decomposition reaction by connecting an electron, which is obtained by ionizing an electrode of magnesium into an Mg²⁺ ion, to another metal body through a wire, the metallic electrode reaction method can control the generation of hydrogen with relation to connection/disconnection of the connected wire, a gap between the electrodes being used and the size of the electrodes.

However, depending on methods of generating hydrogen in accordance with the conventional technology, the size and manufacturing cost of an apparatus for generating hydrogen are increased by using an auxiliary power source like a battery in order to primarily drive a controller that controls the connection/disconnection of a metal electrode.

### SUMMARY

The present invention provides an apparatus for generating hydrogen and a fuel cell power generation system which can make their whole size smaller and reduce their manufacturing cost without an auxiliary power source for starting a controller.

An aspect of the present invention features an apparatus for generating hydrogen. The apparatus in accordance with an embodiment of the present invention can include: an electrolytic bath configured to contain electrolyte solution; an anode placed inside the electrolytic bath and configured to generate an electron; a cathode placed inside the electrolytic bath and configured to generate hydrogen by receiving the electron from the anode; a controller electrically connected to the anode and the cathode, and configured to control flow of electricity between the anode and the cathode; and a mechanical switch electrically connected to the controller in parallel and configured to flow electricity between the anode and the cathode in order to start the controller.

The controller can include an electronic switch that is opened or closed according to an electric signal.

The mechanical switch can be a tact switch, a slide switch, a locker switch or a toggle switch.

Another aspect of the present invention features a fuel cell power generation system. The system in accordance with an embodiment of the present invention can include: an electrolytic bath configured to contain electrolyte solution; an anode placed inside the electrolytic bath and configured to generate an electron; a cathode placed inside the electrolytic bath and configured to generate hydrogen by receiving the electron from the anode; a controller electrically connected to the anode and the cathode, and configured to control flow of electricity between the anode and the cathode; a mechanical switch electrically connected to the controller in parallel, and configured to flow electricity between the anode and the cathode in order to start the controller.; and a fuel cell configured to generate electrical energy by converting chemical energy of the hydrogen generated from the cathode.

The controller can include an electronic switch that is opened or closed according to an electrical signal.

The mechanical switch can be a tact switch, a slide switch, a locker switch or a toggle switch.

### BRIEF DESCRIPTION OF THE DRAWINGS

FIG. 1 is a schematic view showing an embodiment of an apparatus for generating hydrogen according to an aspect of the present invention.

FIG. 2 is a schematic view showing an embodiment of a fuel cell power generation system according to another aspect of the present invention.

### DETAILED DESCRIPTION

An embodiment of an apparatus for generating hydrogen and a fuel cell power generation system according to the present invention will be described in detail with reference to the accompanying drawings. In description with reference to accompanying drawings, the same reference numerals will be assigned to the same or corresponding elements, and repetitive description thereof will be omitted.

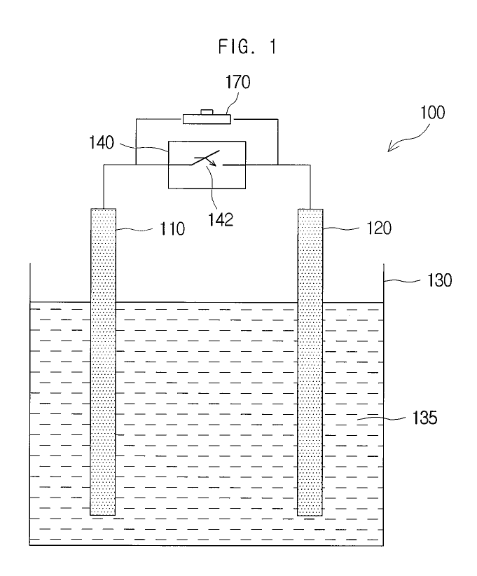

FIG. 1 is a schematic view showing an embodiment of an apparatus for generating hydrogen according to an aspect of the present invention. Illustrated in FIG. 1 are an apparatus 100 for generating hydrogen, an anode 110, a cathode 120, an electrolytic bath 130, an electrolyte solution 135, a controller 140, an electronic switch 142 and a mechanical switch 170.

According to the embodiment of the present invention, an auxiliary power source for starting the controller 140 which controls flow of electricity between the anode 110 and the cathode 120 can be removed by electrically connecting the mechanical switch 170 to the controller 140 in parallel. Therefore, provided is an apparatus 100 for generating hydrogen, whose entire size can be miniaturized and manufacturing cost can be reduced.

The electrolytic bath 130 can contain the electrolyte solution 135 which releases hydrogen through a decomposition reaction. The anode 110 and the cathode 120 are located inside the electrolytic bath 130, so that the electrolyte solution 135 contained inside the electrolytic bath 130 can bring about a hydrogen generation reaction.

LiCl, KCl, NaCl, KNO₃, NaNO₃, CaCl₂, MgCl₂, K₂SO₄, Na₂SO₄, MgSO₄, AgCl, etc can be used as the electrolyte solution 135. The electrolyte solution 135 can include a hydrogen ion.

The anode 110 is an active electrode, placed inside the electrolytic bath 130 and can generate an electron. The anode 110 can be made of, for example, magnesium (Mg). Because of difference between ionization tendencies of the anode 110 and the hydrogen, the anode 110 can be oxidized into a magnesium ion (Mg²⁺) by releasing electrons in the electrolyte solution 135.

Here, electrons being generated can be transferred to the cathode 120. Accordingly, the anode 110 is consumed by generating electrons and configured to be replaced in a certain period of time. The anode 110 can be made of metal having a relatively higher ionization tendency than that of the cathode 120 to be described below.

The cathode 120 is an inactive electrode. Because the cathode, unlike the anode 110, cannot be consumed, it is possible to implement the cathode having thinner thickness than that of the anode 110. The cathode 120 is located inside the electrolytic bath 130 and can generate hydrogen by means of the electrons generated from the anode 110.

The cathode 120 can be made of, for example, stainless steel, and can generate hydrogen by reacting with the electrons. That is, in the chemical reaction at the cathode 120, the electrolyte solution 135 receives electrons transferred from the anode 110 and is decomposed into hydrogen at the cathode 120. The reactions of the anode and cathode are described in the following chemical equation (1).

anode 110: Mg→Mg²⁺+2e⁻

cathode 120: 2H₂0+2e⁻→H₂+2(OH)⁻

full reaction: Mg+2H₂O→Mg(OH)₂+H₂ (1)

The controller 140 is electrically connected to the anode 110 and the cathode 120, and can control flow of electricity between the anode 110 and the cathode 120. The controller 140 receives the amount of hydrogen required by an external device such as a fuel cell and so on. If the amount is large, it is possible to increase the amount of the electrons that flow from the anode 110 to the cathode 120. If the amount is little, it is possible to decrease the amount of the electrons that flow from the anode 110 to the cathode 120.

That is, the controller 140 can be constituted by an electronic circuit that transmits and receives electrical signals. The electronic circuit can include an electronic switch 142 that is opened or closed according to the electrical signal.

For example, the electronic switch 142 constituted by a variable resistor is able to control the amount of electrons flowing between the anode 110 and the cathode 120 by varying the resistance value of the variable resistor, or the electronic switch 142 constituted by an on/off switch is able to control the amount of electrons flowing between the anode 110 and the cathode 120 by controlling the on/off timing.

In the mean time, when the hydrogen starts being generated through the flow of electricity between the anode 110 and the cathode 120, the controller 140 can be driven by receiving a part of the electrical energy that an external device such as a fuel cell, etc., generates through use of the hydrogen generated from the cathode 120.

However, when the apparatus 100 for generating hydrogen is intended to be driven for the first time, that is, when the hydrogen is not generated because there is no flow of electricity between the anode 110 and the cathode 120 so that the external device such as a fuel cell, etc., cannot provide the controller with electrical energy for operating the controller 140, the mechanical switch 170 can be used for initially generating hydrogen for starting the controller 140.

In other words, when driving the apparatus 100 for generating hydrogen for the first time, that is to say, prior to flow of electricity between the anode 110 and the cathode 120, when flowing electricity between the anode 110 and the cathode 120 by intentionally closing the mechanical switch 170 because the controller 140 does not operate, hydrogen can be provided to the external device such as a fuel cell, etc., and the external device such as a fuel cell, etc., generates the electrical energy by using the provided hydrogen so that it can provide the controller 140 with the electrical energy required for starting the controller 140. This matter will be described below again in the description of the mechanical switch 170.

The mechanical switch 170 is electrically connected in parallel to the controller 140 and is able to flow electricity between the anode 110 and the cathode 120 in order to start the controller 140. That is, the mechanical switch 170 is electrically connected in parallel to the controller 140 electrically connected to the anode 110 and the cathode 120. As a result, even though the controller 140 does not operate at the time of driving the apparatus 100 for generating hydrogen for the first time, it is possible to generate hydrogen by purposely flowing electricity between the anode 110 and the cathode 120 in accordance with needs of users.

In this case, as described above, it is adequate to operate the mechanical switch 170 such that only sufficient hydrogen to start the controller 140 is generated. Therefore, the apparatus 100 for generating hydrogen can be effectively started even by closing the mechanical switch 170 only during the time corresponding to the generation of the hydrogen.

As such, the controller 140 of the apparatus 100 for generating hydrogen is started by using the mechanical switch 170, so that it is possible to miniaturize the overall size of the apparatus 100 for generating hydrogen and reduce the manufacturing cost thereof, as compared with a conventional technology using the auxiliary power source such as a batter and the like.

Meanwhile, the mechanical switch 170 can be a tact switch, a slide switch, a locker switch or a toggle switch. A user can generate hydrogen from the cathode 120 by flowing electricity between the anode 110 and the cathode 120 through simple operations of the tact switch, the slide switch, the locker switch or the toggle switch mentioned above in accordance with the user's needs.

Next, a fuel cell power generation system having an apparatus for generating hydrogen according to an aspect of the present invention will be described.

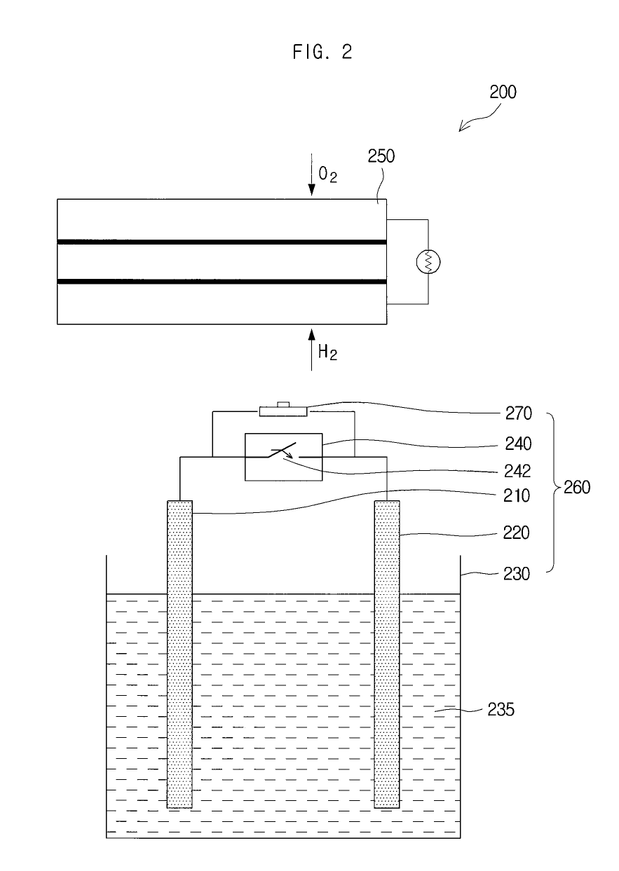

FIG. 2 is a schematic view showing an embodiment of a fuel cell power generation system according to another aspect of the present invention. In FIG. 2, illustrated are a fuel cell power generation system 200, a fuel cell 250, an apparatus 260 for generating hydrogen, an anode 210, a cathode 220, an electrolytic bath 230, an electrolyte solution 235, a controller 240, an electronic switch 242 and a mechanical switch 270.

According to the embodiment of the present invention, an auxiliary power source for starting the controller 240 which controls flow of electricity between the anode 210 and the cathode 220 can be removed by electrically connecting the mechanical switch 270 to the controller 240 in parallel. Therefore, provided is a fuel cell power generation system 200, whose entire size can be miniaturized and manufacturing cost can be reduced, and consequently capable of more stably generating the electrical energy.

In the embodiment of the present invention, since the construction and operation of the apparatus 260 for generating hydrogen, the anode 210, the cathode 220, the electrolytic bath 230, the electrolyte solution 235, the controller 240, the electronic switch 242 and the mechanical switch 270 are the same as or correspond to those of the embodiment described above, descriptions thereof will be omitted. Hereafter, a difference from the embodiment described above, that is, the fuel cell 250 will be described.

The fuel cell 250 can generate electrical energy by converting the chemical energy of the hydrogen generated by the cathode 220. The pure hydrogen generated by the apparatus 260 for generating hydrogen can be transferred to the fuel electrode of the fuel cell 250. Therefore, a direct current can be generated by converting the aforesaid chemical energy of the hydrogen generated by the apparatus 260 for generating hydrogen into electrical energy.

That is, when driving the apparatus 260 for generating hydrogen for the first time, the fuel cell 250 is able to generate the electrical energy by receiving the hydrogen generated through the intentional closing of the mechanical switch 270. A part of the electrical energy is provided to the controller 240 and the controller 240 can be started.

Subsequently, the started controller 240 can flow electricity between the anode 210 and the cathode 220, thereby providing the hydrogen generated by the cathode 220 for the fuel cell 250.

Then, the fuel cell 250 can generate the electrical energy by converting the chemical energy of the hydrogen and provide a part of the electrical energy for driving the controller 240. Accordingly, the apparatus 260 for generating hydrogen is capable of continuously generating hydrogen.

Numerous embodiments other than embodiments described above are included within the scope of the present invention.

What is claimed is:

1. An apparatus for generating hydrogen comprising:
an electrolytic bath configured to contain electrolyte solution;
an anode placed inside the electrolytic bath and configured to generate an electron;
a cathode placed inside the electrolytic bath and configured to generate hydrogen by receiving the electron from the anode;
a controller electrically connected to the anode and the cathode, and configured to control flow of electricity between the anode and the cathode; and
a mechanical switch electrically connected to the controller in parallel and configured to flow electricity between the anode and the cathode in order to start the controller.

2. The apparatus of claim 1, wherein the controller comprises an electronic switch that is opened or closed according to an electrical signal.

3. The apparatus of claim 1, wherein the mechanical switch is a tact switch, a slide switch, a locker switch or a toggle switch.

4. A fuel cell power generation system comprising:
an electrolytic bath configured to contain electrolyte solution;
an anode placed inside the electrolytic bath and configured to generate an electron;
a cathode placed inside the electrolytic bath and configured to generate hydrogen by receiving the electron from the anode;
a controller electrically connected to the anode and the cathode, and configured to control flow of electricity between the anode and the cathode;
a mechanical switch electrically connected to the controller in parallel, and configured to flow electricity between the anode and the cathode in order to start the controller; and
a fuel cell configured to generate electrical energy by converting chemical energy of the hydrogen generated from the cathode.

5. The system of claim 4, wherein the controller comprises an electronic switch that is opened or closed according to an electrical signal.

6. The system of claim 4, wherein the mechanical switch is a tact switch, a slide switch, a locker switch or a toggle switch.
